(19) United States
(12) Patent Application Publication
(10) Pub. No.: US 2015/0244228 A1
(43) Pub. Date: Aug. 27, 2015

(54) Electric Generator and Turbine Comprising the Same

(71) Applicants: Andre BEAULIEU, St-Marc Sur Richelieu (CA); Gaetan MATHIEU, Varennes (CA)

(72) Inventors: Andre BEAULIEU, St-Marc Sur Richelieu (CA); Gaetan MATHIEU, Varennes (CA)

(21) Appl. No.: 14/629,866

(22) Filed: Feb. 24, 2015

Related U.S. Application Data
(60) Provisional application No. 61/943,747, filed on Feb. 24, 2014.

(51) Int. Cl. H02K 3/28; H02K 11/00; F03D 9/00; H02K 1/27

(52) U.S. Cl. CPC H02K 3/28; H02K 1/27; H02K 11/0073; F03D 9/002

(57) ABSTRACT

An electric generator for use with a turbine (e.g. wind turbine) is disclosed. The generator comprises a stator and a rotor mounted for rotation with respect to the stator. The rotor comprises an even number M of magnets and the stator comprises an odd number C of coils. The number M of magnets and the number C of coils are chosen such that they do not have a common divider except 1. The coils are also generally made of a large number of turns of small wires such that each coil outputs high voltage but low current. In addition, the output of each one of the coils is generally rectified individually. An electric generator assembly is also disclosed. The generator of the invention is connected to a turbine, preferably a wind turbine, for rotating the rotor of the generator. A method for producing electricity is also disclosed.

### CROSS-REFERENCE TO RELATED APPLICATIONS

The present application claims priority of U.S. provisional application No. 61/943,747 filed on Feb. 24, 2014, the content of which is incorporated herewith by reference.

### FIELD OF THE INVENTION

The present invention generally relates to electric generators and more particularly to electric generators for use with turbines such as, but not limited to, wind turbines.

### BACKGROUND OF THE INVENTION

Wind power is increasingly harvested as a source of renewable power. Typically, wind power is converted into electricity by rotating the blades of a turbine which, in turn, rotates a rotor in an electric generator.

In a typical electric generator configuration, a rotor, which is directly or indirectly connected to the wind turbine, is pivotally mounted within a stator. In such configuration, the rotor is provided with an even number of magnets which are disposed about its periphery in alternating polarity. For its part, the stator is provided with a predetermined number of coils or coil assemblies (i.e. a magnetic core surrounded by a coil of wire). The coil assemblies are positioned such as to be temporarily aligned with the rotor magnets when the rotor rotates within the generator.

To prevent electrical power cancellation between coils, the number of coil assemblies is a multiple of the number of magnets (or both numbers share common dividers). Though such configuration offers several advantages, it also has a major shortcoming in the form of “cogging”.

Cogging occurs when pairs of rotor and stator magnets are aligned and the attractive magnetic force between them must be overcome to allow the rotation of the rotor.

Several techniques have been proposed throughout the years to reduce cogging.

For instance, one technique suggests offsetting some of the stator coil assemblies to create misalignment between some of the rotor and stator magnets. Another technique suggests changing the width or angle of the rotor and/or stator magnets.

Still, despite past attempts to reduce cogging in electrical generators, there is still a need for an improved electric generator in which cogging is further mitigated.

### SUMMARY OF THE INVENTION

The shortcomings of the prior art are generally mitigated by an electric generator in which the number M of rotor magnets and the number C of stator coil assemblies (i.e. a magnetic core surrounded by a coil of wire) are selected such that there is no common integer divider between them other than 1.

The invention is directed to a generator for generating electricity, the generator comprising;
a rotor comprising an even number M of magnets; and
a stator comprising an odd number C of coil assemblies; the rotor being operatively connected to the stator such as the coil assemblies are positioned on the stator to be temporarily aligned with the magnets of the rotor when the rotor rotates within the generator for generating electricity;
   wherein the number M of magnets and the number C of coil assemblies do not have a common integer divider other than 1, whereby in use only one magnet of the M number of magnets and one coil assembly are perfectly aligned at any given time.

The invention is also directed to an electric generator assembly for producing electricity, the assembly comprising a turbine, preferably a wind turbine, operatively connected to a generator,
the generator comprising;
   a rotor comprising an even number M of magnets, the rotor being
operatively connected to the turbine for rotation; and
   a stator comprising an odd number C of coil assemblies; the rotor being operatively connected to the stator such as the coil assemblies are positioned on the stator to be temporarily aligned with the magnets of the rotor when the rotor rotates within the generator for generating electricity;
      wherein the number M of magnets and the number C of coil assemblies do not have a common integer divider other than 1, whereby in use only one magnet of the M number of magnets and one coil assembly are perfectly aligned at any given time.

The invention is also directed to a method for producing electricity. The method comprises the step of rotating a rotor within an electric generator, the electric generator comprising the rotor operatively connected to a stator; the rotor comprising an even number M of magnets and the stator comprises an odd number C of coil assemblies such as the coil assemblies are positioned on the stator to be temporarily aligned with the magnets of the rotor when rotating the rotor within the generator for generating electricity; the number M of magnets and the number C of coil assemblies do not have a common integer divider other than 1, whereby in use only one magnet of the M number of magnets and one coil assembly are perfectly aligned at any given time.

By choosing numbers M and C such that there is no common divider between them except 1, only one magnet and one stator coil assembly are perfectly aligned at any given time. Understandably, all the other rotor magnets and stator coil assemblies are more or less misaligned, thereby forming a fundamentally unstable configuration as most magnets and stator coil assemblies are trying to align themselves. Hence, such a configuration of rotor magnets and stator coil assemblies exhibits significantly less cogging.

In accordance with one embodiment of the invention, the stator of the generator may surround the rotor, the magnets being then disposed about a periphery of the rotor in alternating polarity. In this case, the number C of coils may be greater than the number M of magnets.

In accordance with another embodiment of the invention, the rotor of the generator may surround the stator, the magnets being then disposed about an inside edge of the rotor in alternating polarity. In this case, the number C of coils may be smaller than the number M of magnets.

The number M of rotor magnets is generally an even number due to the requirement of having magnets of alternating polarity.

In typical yet non-limitative embodiments in accordance with the principles of the present invention, the number C of stator coil assemblies is an odd number which has no common divider with the number M except 1.

In typical yet non-limitative embodiments in accordance with the principles of the present invention, the number C of stator coil assemblies is a prime number.

In typical yet non-limitative embodiments in accordance with the principles of the present invention, the coil of each coil assembly is made of a large number of turns (e.g. 3000 to 8000) of a wire having a small diameter (e.g. 28 to 38 American wire gauge—AWG) such that each coil assembly outputs high voltage but low current.

In typical yet non-limitative embodiments in accordance with the principles of the present invention, the output of each coil assembly is rectified individually before being combined in parallel with the outputs of the other coil assemblies. In such embodiments, the combined output of all the coil assemblies is substantially DC wattage.

In typical yet non-limitative embodiments in accordance with the principles of the present invention, the electric generator is directly or indirectly (e.g. through a transmission) coupled to a wind turbine such as to generate electrical power from wind.

Other and further aspects and advantages of the present invention will be better understood from the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is an axial view of the rotor and stator of an embodiment of a prior art electric generator.

FIG. 2 is an axial view of the rotor and stator of an embodiment of an electric generator in accordance with one preferred embodiment of the present invention.

FIG. 2A is an enlarged axial view of a magnet and coil assembly of the generator of FIG. 2.

FIG. 3 is a schematic view of an electric generator assembly comprising a wind turbine connected to an electric generator in accordance with one preferred embodiment of the present invention.

### DETAILED DESCRIPTION OF THE PREFERRED EMBODIMENT

A novel electric generator and an electric generator assembly comprising the same will be described hereinafter. Although the invention is described in terms of specific illustrative embodiments, it is to be understood that the embodiments described herein are by way of example only and that the scope of the invention is not intended to be limited thereby.

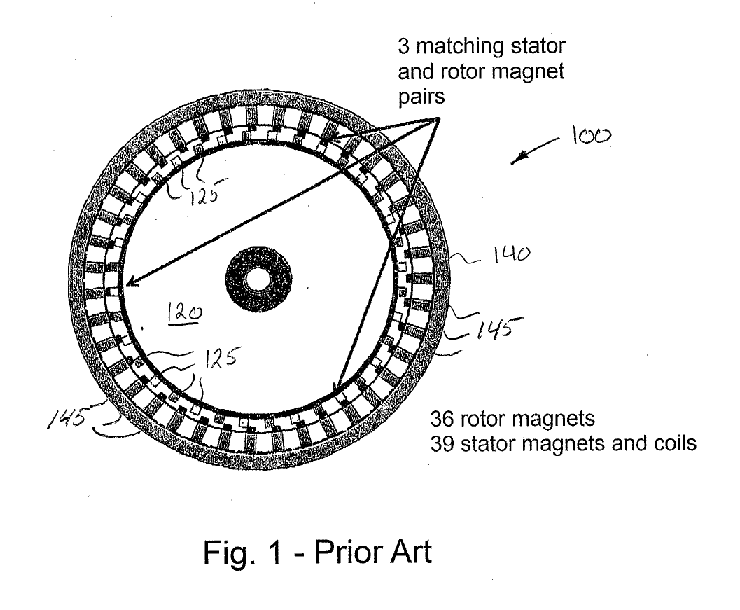

Referring first to FIG. 1, an embodiment of a prior art electric generator 100 is illustrated. The generator 100 comprises a rotor 120 mounted for rotation within a stator 140. The rotor 120 comprises an even number of permanent magnets 125 mounted about its outer periphery. As shown in FIG. 1 and as is known in the art, the permanent magnets 125 are mounted such that adjacent magnets 125 have opposed polarity.

For its part, the stator 140 comprises a plurality of coil assemblies 145 mounted about its inner periphery.

In the embodiment shown in FIG. 1, which is typical of prior art generators, the number of magnets 125 is 36 and the number of coil assemblies 145 is 39. As best shown in FIG. 1, with such numbers of magnets 125 and coil assemblies 145, at any moment, three pairs of magnets 125 and coil assemblies 145 are aligned since numbers 36 and 39 share 3 as common divider. So, with such a configuration, the attractive magnetic force between the three pairs of aligned magnets 125 and coil assemblies 145 must be overcome when the rotor 120 starts rotating. This force that must be overcome is generally referred to as “cogging” or “cogging force”.

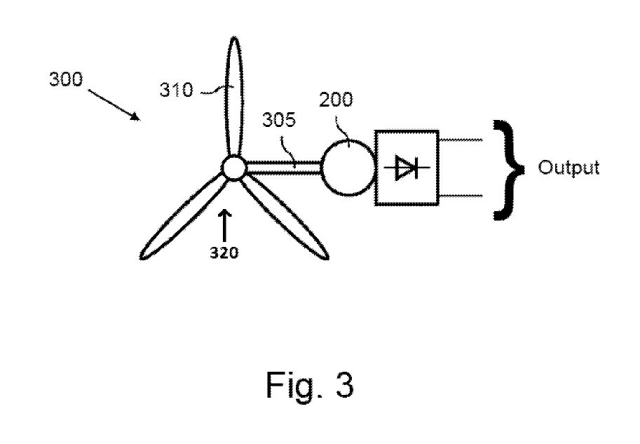

It is to be understood that when a wind turbine 300 (see FIG. 3) is coupled to an electric generator such as the one shown in FIG. 1, cogging prevents the wind turbine 300 from rotating unless the wind is strong enough to overcome the cogging force. Hence, cogging prevents wind turbines from generating electricity in low wind conditions. However, low wind conditions are generally more prevalent than medium and high wind conditions.

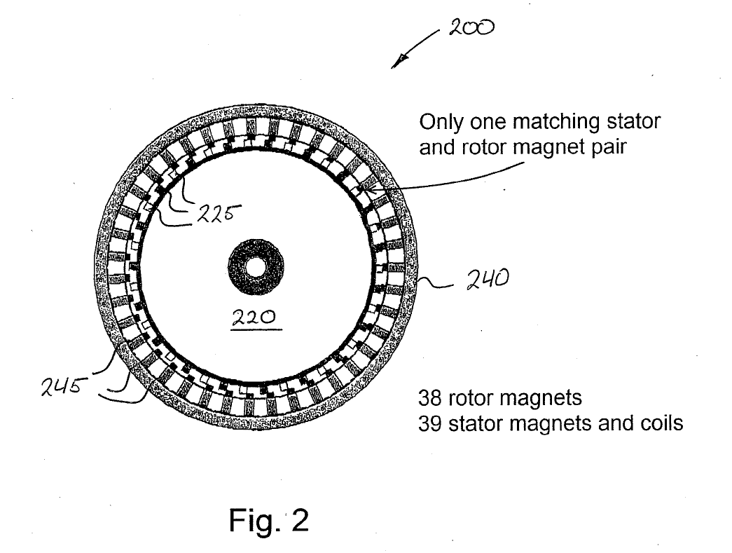

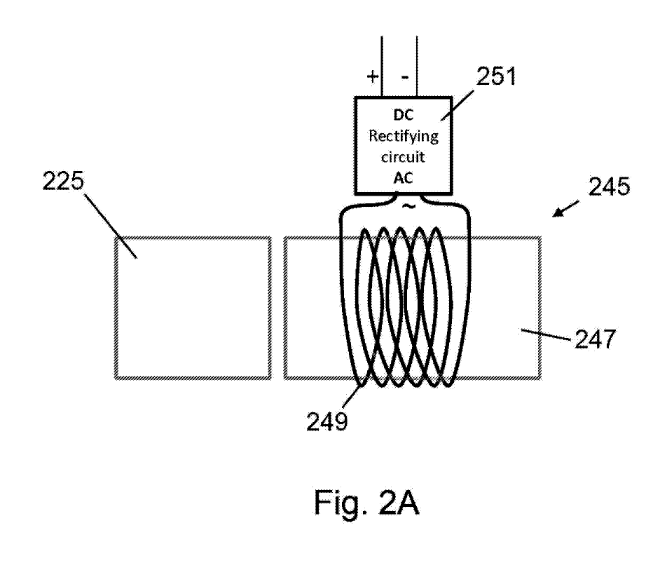

Referring now to FIG. 2, an embodiment of an electric generator 200 in accordance with the principles of the present invention is shown. Similar to the generator 100, the generator 200 comprises a rotor 220 mounted for rotation within a stator 240.

The rotor 220 comprises an even number of permanent magnets 225 mounted about its outer periphery. As shown in FIG. 2 and as is known in the art, the permanent magnets 225 are mounted such that adjacent magnets 225 have opposed polarity.

For its part, the stator 240 comprises a plurality of coil assemblies 245 mounted about its inner periphery.

In accordance with the principles of the present invention, the number M of magnets 225 and the number C of coil assemblies 245 have no common integer divider except 1. When such a condition is met as in FIG. 2, only one magnet 225 and one coil assembly 245 are perfectly aligned at any given moment. All the other magnets 225 and coil assemblies 245 are more or less misaligned.

Understandably, such a configuration greatly reduces cogging as the attractive magnetic force existing between only one pair of magnet 225 and coil assembly 245 needs to be overcome to impart rotation to the rotor 220. Hence, when a generator such as generator 200 is coupled to a wind turbine 300 (see FIG. 3) through a shaft 305 or other transmission mechanisms (e.g. transmission), the wind turbine 300 can start generating electricity in lower wind conditions as the wind needs to overcome much less cogging force to cause the rotor 220 to rotate.

In addition, since all the other magnets 225 and coil assemblies 245 are more or less misaligned, the rotor 220 is fundamentally unstable since the other almost aligned magnets 225 and coil assemblies 245 are constantly trying to fully align themselves. The instability caused by the constant magnetic tugging between pairs of magnets 225 and coil assemblies 245 further assists the rotor 220 in overcoming cogging.

So, the generator 200 not only exhibits less cogging than prior art generators such as generator 100, the reduced cogging it exhibits is further more easily overcome by the fundamental instability of the rotor 220.

In the embodiment of the generator 200 shown in FIG. 2, the number M of magnets is 38 and the number C of coil assemblies is 39. Understandably, the sole common divider between 38 and 39 is 1.

In other embodiments, the number C of coil assemblies could be a prime number. For example, the number M of magnets could be 42 and the number C of coil assemblies could be 43. In such embodiments, the sole common integer divider between numbers C and M would still be 1.

Understandably, the difference (i.e. C minus M) between numbers C and M needs not be only 1. For instance, the number C of coil assemblies 245 could be 43 and the number M of magnets could be 40 or even 38. Another example would be M=36 for C=41.

Also, due to the mechanical configuration of the rotor 220 and stator 240, the number C of coil assemblies 245 is generally selected to be greater than the number M of magnets 225. However, in some embodiments, the number C of coil assemblies 245 could possibly be selected to be lower than the number M of magnets 225.

Referring to FIG. 2A, each coil assembly 245 comprises a central magnetic core 247 surrounded by a coil of wire 249. In the present embodiment, the coil of wire 249 is made from a large number of turns (e.g. 3000 to 8000) of a wire having a small diameter (e.g. 28 to 38 AWG). So, for the same amount of amp-turns, each coil assembly 245 generates a higher voltage but a much lower current.

It is to be understood that high voltages (e.g. between 300 to 900 V) are more easily managed than high currents (e.g. more than 2 A) and high-voltage electric components are generally less expensive than high-current electric components. Hence, it is advantageous for the generator 200 to generate high voltage but low current per coil assembly 245.

In addition, as shown in FIG. 2A, in the present embodiment, the output of each coil assembly 245 is rectified individually with a voltage rectifier circuit 251 and then combined in parallel to form substantially DC wattage.

In that sense, due to the configuration of the magnets 225 and coil assemblies 245, at any given moment, only one magnet 225 and one coil assembly 245 are fully aligned. Hence, the outputs of the coil assemblies 245 are all slightly temporally offset and are thus never superposed. This slight temporal offset of the outputs of the coil assemblies 245 contributes to generating substantially DC voltage at the output of the generator 200.

Referring now to FIG. 3, an electric generator assembly 300 is illustrated. In typical use, the generator 200 would generally be coupled, directly or through a transmission 305, to a wind turbine 320.

As the wind causes the blades 310 of the wind turbine 320 to rotate, the turbine 310 will cause the rotor 220 to also rotate within the stator 240. However, since the generator 200 exhibits less cogging than prior art generators, the rotor 200 can start generating electricity in lower wind conditions as compared to prior art generators. Understandably, if the rotor 200 can rotate in lower, and generally more prevalent, wind conditions, the wind turbine 320 and the generator 200 can start generating electricity in lower wind conditions.

It is to be understood that the invention is not limited to the configuration detailed herein. According to another embodiment of the present invention, the position of the magnet and the stator coil can be reversed by placing the magnets outside the coil inside within the generator.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A generator for generating electricity, the generator comprising;
a rotor comprising an even number M of magnets; and
a stator comprising an odd number C of coil assemblies; the rotor being operatively connected to the stator such as the coil assemblies are positioned on the stator to be temporarily aligned with the magnets of the rotor when the rotor rotates within the generator for generating electricity;
wherein the number M of magnets and the number C of coil assemblies do not have a common integer divider other than 1, whereby in use only one magnet of the M number of magnets and one coil assembly are perfectly aligned at any given time.

2. The generator of claim 1, wherein the stator surrounds the rotor, the magnets being then disposed about a periphery of the rotor in alternating polarity.

3. The generator of claim 2, wherein the number C of coils is greater than the number M of magnets.

4. The generator of claim 1, wherein the rotor surrounds the stator, the magnets being then disposed about an inside edge of the rotor in alternating polarity.

5. The generator of claim 4, wherein the number C of coils is smaller than the number M of magnets.

6. The generator of claim 1, wherein the number C of coils is a prime number.

7. The generator of claim 1, wherein each coil assembly of the generator comprises a voltage rectifier circuit to rectify an output of each coil assembly.

8. The generator of claim 7, wherein all outputs of all voltage rectifier circuits of the generator are connected in parallel.

9. The generator of claim 1, wherein each of the coil assembly comprises a central magnetic core surrounded by a coil of a wire, a number of turns of the wire being between 3000 to 8000 turns, the wire having a diameter of between 28 to 38 gauges.

10. The generator of claim 1, wherein the rotor of the generator is operatively connected to a turbine, the turbine allowing the rotor to rotate within the generator for producing electricity.

11. The generator of claim 10, wherein the turbine is a wind turbine.

12. An electric generator assembly for producing electricity, the assembly comprising a turbine operatively connected to a generator,
the generator comprising;
a rotor comprising an even number M of magnets, the rotor being operatively connected to the turbine for rotation; and
a stator comprising an odd number C of coil assemblies; the rotor being operatively connected to the stator such as the coil assemblies are positioned on the stator to be temporarily aligned with the magnets of the rotor when the rotor rotates within the generator for generating electricity;
wherein the number M of magnets and the number C of coil assemblies do not have a common integer divider other than 1, whereby in use only one magnet of the M number of magnets and one coil assembly are perfectly aligned at any given time.

13. The electric generator assembly of claim 12, wherein the stator surrounds the rotor, the magnets being then disposed about a periphery of the rotor in alternating polarity.

14. The electric generator assembly of claim 13, wherein the number C of coils is greater than the number M of magnets.

15. The electric generator assembly of claim 12, wherein the rotor surrounds the stator, the magnets being then disposed about an inside edge of the rotor in alternating polarity.

16. The electric generator assembly of claim 15, wherein the number C of coils is smaller than the number M of magnets.

17. The electric generator assembly of claim 12, wherein the number C of coils is a prime number.

18. The electric generator assembly of claim 12, wherein each coil assembly of the generator comprises a voltage rectifier circuit to rectify an output of each coil assembly.

19. The electric generator assembly of claim 18, wherein all outputs of all voltage rectifier circuits of the generator are connected in parallel.

20. The electric generator assembly of claim 12, wherein the turbine is a wind turbine.
